(19) United States
(12) Patent Application Publication
(10) Pub. No.: US 2025/0075681 A1
(43) Pub. Date: Mar. 6, 2025

(54) BEARING BUSH, BEARING BUSH ASSEMBLY, AND WIND TURBINE BEARING FOR WIND TURBINES

(71) Applicant: EFFBE GmbH, Bad Soden-Salmuenster (DE)

(72) Inventors: Michael Schäddel, Alzenau (DE); Wolfgang Spatzig, Chemnitz (DE)

(73) Assignee: EFFBE GmbH, Bad Soden-Salmuenster (DE)

(21) Appl. No.: 18/292,623

(22) PCT Filed: Jul. 26, 2022
(86) PCT No.: PCT/EP2022/070864

§ 371 Date: Jan. 26, 2024

(30) Foreign Application Priority Data
Jul. 27, 2021 (DE) 10 2021 119 470.9

(51) Int. Cl. F03D 80/70; F16C 27/06

(52) U.S. Cl. CPC F03D 80/703; F16C 27/063; F05B 2240/54; F16C 2229/00; F16C 2360/31

(57) ABSTRACT

A bearing bush for movably holding a generator-side component and a foundation-side component of a wind turbine may include an elastomer body having a cavity for receiving a foundation-side or generator-side bearing bolt defining a longitudinal direction, and a tensioning assembly adapted to compress the elastomer body on both sides in the longitudinal direction in such a way that it exerts a pretensioning force directed in the longitudinal direction on both sides of the elastomer body when compressing the elastomer body.

### CROSS REFERENCE TO RELATED APPLICATIONS

This patent application is a U.S. national stage application of PCT International application No. PCT/EP2022/070864, filed Jul. 26, 2022, which claims priority to German Patent Application No. 102021119470.9, filed Jul. 27, 2021. Each of these applications is incorporated herein by reference in its entirety.

### BACKGROUND

### Field

The present disclosure relates to a bearing bush for movable support of a generator-side component, such as a gear and/or a generator, and a foundation-side component of a wind turbine, a wind turbine bearing for supporting a generator and/or a gear of a wind turbine on a foundation-side support structure of the wind turbine and a bearing bush arrangement.

### Related Art

In wind turbines, a large torque is usually transmitted from the rotor to the generator via a gearbox. Elastic bushings are usually used to reduce the dynamic loads on the gear and support structure. The elastic bushings are used to decouple vibrations and oscillations. For this purpose, a wind turbine bearing for a machinery train of the wind turbine has, for example, a flange with mounting openings. Mounting units, in particular threaded rods or bearing bolts, are attached in the through openings by means of elastomer bodies that serve as dampers. Furthermore, the mounting elements are connected, in particular screwed, to the support structure, in particular the housing of the wind turbine.

A wind turbine bearing is known from EP 2 352 930 B1, in which a flange is tensioned to the gear via two elastomer bodies. At least one of the elastomer bodies is shaped conically and has an angle of approximately 45° in order to be able to transmit forces acting radially and axially to an axial direction between the flange and the gear. In the bearing according to EP 2 352 930 B1, the one-sided tensioning of the elastomer bodies has proven to be disadvantageous. Furthermore, the use of the mounting bolt of the machine carrier and mounting flange for tensioning the elastomer bodies has also proven to be disadvantageous. This is because axial shear forces occur when the elastomer bodies are tensioned on one side, which are undesirable. On the other hand, the mounting bolt, on which both the mounting flange and the machine carrier are mounted, moves in the direction of the tensioning component, which is formed as a pressure plate and is provided with a bore that accommodates the bolt, which leads to the machine carrier and mounting flange starting to move, namely towards each other.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 a front view of a bearing bush according to the disclosure.

FIG. 2 a sectional view of the bearing bush from FIG. 1 along line I-I in FIG. 1 in an uncompressed state.

FIG. 3 a sectional view of the bearing bush from FIG. 1 along line I-I in FIG. 1 in a compressed state.

FIG. 4 a front view of a bearing bush according to the disclosure.

FIG. 5 a sectional view of the bearing bush from FIG. 4 along line II-II in FIG. 4 in an uncompressed state.

FIG. 6 a sectional view of the bearing bush from FIG. 4 along line II-II in FIG. 4 in a compressed state.

FIG. 7 a perspective view of an elastomer body of a bearing bush according to the disclosure.

FIG. 8 a perspective sectional view of the elastomer body from FIG. 7.

FIG. 9 a perspective view of an elastomer body of a bearing bush according to the disclosure.

FIG. 10 a perspective sectional view of the elastomer body from FIG. 9.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, and components have not been described in detail to avoid unnecessarily obscuring embodiments of the disclosure.

An object of disclosure is to overcome the disadvantages of the known prior art, in particular to provide a bearing bush, a bearing bush arrangement, a wind turbine bearing and/or a wind turbine in which the elastomer bodies are loaded less, assembly is simplified and/or operation of the wind turbine is ensured more reliably.

Accordingly, a bearing bush is provided for movably holding a generator-side component and a foundation-side component of a wind turbine. For example, a bearing bush is provided for an elastic bearing of a wind turbine. Elastic bearings are used in wind turbines to absorb dynamic loads acting on the components of the wind turbine. The bearing bush can be used to damp and decouple oscillations and/or vibrations.

The generator-side component can, for example, be part of the machine train of the wind turbine, which comprises the rotor, the generator and transmission elements arranged in between, such as a gear, a shaft or a coupling. In particular, the generator-side component can be a shaft bearing for a drive shaft of the machine train. The shaft bearing may have a bearing opening in which the shaft of the machine train is mounted. The foundation-side component can be a support structure of the wind turbine, which is formed, for example, by the housing of the wind turbine.

For example, the foundation-side component may be a housing that is part of the nacelle of the wind turbine, and the generator-side component may be a shaft bearing or a gear of the wind turbine. A bearing bush according to the disclosure supports the generator-side component in a damped manner in all spatial directions relative to the foundation-side component of the wind turbine. For example, the bearing bush elastically dampens a generator-side component on a foundation-side support structure.

According to the disclosure, the bearing bush comprises an elastomer body with a cavity for receiving a foundation-side or generator-side bearing bolt, which is, for example, screwed to the foundation-side or generator-side component and protrudes through a through bore of the other component. The bearing bolt defines a longitudinal direction of the bearing bush. The inner side of the elastomer body can be in contact with the bearing bolt. The outside of the elastomer body can be in contact with the foundation-side or generator-side component, in particular with the through bore of the foundation-side or generator-side component. In particular, it may be provided that the elastomer body is arranged completely in the through bore of the foundation-side or generator-side component, i.e. does not protrude from the through bore in the longitudinal direction of the bearing bolt.

The bearing bush also comprises a tensioning assembly which is designed to compress the elastomer body on both sides in the longitudinal direction in such a way that, when compressing the elastomer body, it exerts a longitudinally directed pretensioning force on both sides of the elastomer body. It may be provided that the tensioning device compresses the elastomer body from both sides equally and/or simultaneously. In other words, when the tensioning assembly is activated, it applies pretensioning forces oriented in opposite directions to the elastomer body on both end or face sides of the elastomer body, so that the elastomer body is compressed or axially compressed equally from both sides in particular. The pretensioning force compresses the elastomer body in the longitudinal direction and expands it correspondingly in the radial direction, thus transversely to the longitudinal direction, and a force-fit connection is created between the elastomer body and the foundation-side or generator-side component. This allows the elastomer body and thus the bearing bolt to be fixed to the foundation-side or generator-side component or in the through bore of the foundation-side or generator-side component. By compressing the elastomer body on both sides, no undesirable shear forces are created and displacement of the elastomer body in the longitudinal direction can also be prevented. In this way, it can be ensured that a distance in the longitudinal direction between the generator-side component and the foundation-side component, which can for example be in the portion of 5 to 20 mm, remains the same in the compressed and uncompressed state of the elastomer body or changes by a maximum of 10%. In addition, a bearing bush according to the disclosure offers the advantage that it can be manufactured and mounted simply and inexpensively. In particular, the bearing bush can be mounted from one side of the wind turbine bearing without the need for difficult-to-handle hydraulic tensioning tools. For example, the bearing bush can be pre-assembled on the bearing bolt.

According to an exemplary embodiment, the bearing bush also comprises a support bush supporting the elastomer body transversely to the longitudinal direction for bearing the tensioning assembly. The support bush serves to guide the tensioning device and to provide the necessary mounting space for the tensioning device. For example, the support bushing can be inserted into the cavity of the elastomer body and be in contact with the inner side of the elastomer body so that it is arranged between the elastomer body and the bearing bolt in the assembled state. The elastomer body may be pre-assembled on the support bushing for easy and cost-effective manufacture and assembly.

According to a further aspect of the present disclosure, which can be combined with the preceding aspects and exemplary embodiments, a bearing bush for movably supporting a generator-side component and a foundation-side component of a wind turbine is provided.

The bearing bush comprises an inner elastomer body for supporting on a foundation-side or generator-side bearing bolt, which is, for example, screwed to the foundation-side or generator-side component and protrudes through a through bore of the other component. The bearing bolt defines a longitudinal direction of the bearing bush. The bearing bush also comprises an outer elastomer body for supporting on the foundation-side or generator-side component. In particular, the outer elastomer body can be supported on the through bore of the foundation-side or generator-side component. In particular, it may be provided that the inner and outer elastomer bodies are arranged completely in the through bore of the foundation-side or generator-side component.

The bearing bush also comprises a tensioning assembly with a support bush arranged between the elastomer bodies and supported on both elastomer bodies, wherein the tensioning assembly is designed to compress at least one of the elastomer bodies in the longitudinal direction. The support bush serves to guide the tensioning assembly and to keep the necessary mounting space free between the inner and outer elastomer bodies. In other words, the support bushing separates the inner elastomer body from the outer elastomer body. It may be provided that the inner and/or outer elastomer body is/are pressed onto the bearing bolt or pressed into the through bore of the foundation-side or generator-side component. The bearing bush according to the disclosure can be manufactured and mounted easily and cost-effectively due to the separation of the elastomer body into two parts and the support bushing arranged between them. In particular, the bearing bush can be mounted from one side of the wind turbine bearing without the need for difficult-to-handle hydraulic tensioning tools. When compressing the elastomer bodies in the longitudinal direction, at least one of the elastomer bodies expands radially and forms a force-fit connection with the foundation-side or generator-side component and/or the bearing bolt. This fixes the bearing bush and thus the bearing bolt to the foundation-side or generator-side component or in the bore of the foundation-side or generator-side component. The bearing bush according to the disclosure means that no axial shear forces are created when compressing the elastomer body. It can also be ensured that the foundation-side and generator-side components do not shift and that a distance in the longitudinal direction between the generator-side component and the foundation-side component, which can for example be in the range of 5 to 20 mm, remains the same in the compressed and uncompressed state of the elastomer body or changes by a maximum of approximately 10%.

According to an exemplary embodiment, the tensioning assembly has an unloaded state and a tensioned state. In the unloaded state, both elastomer bodies are in an essentially uncompressed state. In the tensioned state, exactly one elastomer body, in particular the outer elastomer body, is compressed in the longitudinal direction and the other elastomer body, in particular the inner elastomer body, remains essentially uncompressed. In this embodiment, only the outer elastomer body expands radially during tensioning to fix the entire element in the bore of the foundation-side or generator-side component and fixes the entire system. This allows the necessary pretensioning force to be reduced.

In another exemplary embodiment, the support bushing has a rotationally shaped, hollow jacket which has a through bore for the tensioning assembly, the inner-side jacket face of which is supported on the inner elastomer body or on the bearing bolt and the outer-side jacket face of which is supported on the outer elastomer body. The support bush can be embodiment cylindrically and/or with a low wall thickness.

According to a further aspect of the present disclosure, which can be combined with the preceding aspects and exemplary embodiments, a bearing bush is provided for movably holding a generator-side component and a foundation-side component of a wind turbine.

The bearing bush comprises one, in particular at least one, elastomer body with a cavity for receiving a foundation-side or generator-side bearing bolt defining a longitudinal direction. The bearing bush also comprises a tensioning assembly for compressing the at least one elastomer body in the longitudinal direction.

According to the disclosure, the at least one elastomer body has a stiffness that varies in the longitudinal direction, which may also be referred to as axial stiffness. For example, the elastomer body is arranged and/or designed in such a way that at least two axial sections of the elastomer body are formed, which have a different axial stiffness. Thus, on one hand, the considerable load requirements can be fulfilled, particularly in the radial direction, and at the same time the axial stiffness can be adjusted depending on the specific requirements. In particular, the inventors of the present disclosure have succeeded in being able to adjust the axial stiffness at least to a certain extent independently of the radial stiffness. The flexible design of the axial or radial stiffness of the bearing bush enables further savings to be achieved with regard to material requirements, mounting space and thus also costs. In the present case, axial stiffness can be understood as the resistance of the bearing bush, in particular of the at least one elastomer body, to elastic deformation due to an external force application, in particular in the longitudinal direction, for example a shear or tensile load. Radial stiffness can be understood herein as the resistance of the bearing bush or the elastomer body to elastic deformation when a force is applied transversely, in particular radially, to the longitudinal axis. The varying axial stiffness can be achieved, for example, by the elastomer body being segmented, in particular by having different radial wall thicknesses in the longitudinal direction. Furthermore, it is possible to design the radial stiffness depending on the orientation, wherein, for example, the radial stiffness in the horizontal direction can be greater or less than the radial stiffness in the vertical direction.

In an exemplary embodiment, the tensioning assembly has a tensioning device and a counter bearing movably mounted with respect to the tensioning device for applying a compression force in the longitudinal direction to the at least one elastomer body. It may be provided that the tensioning device applies a compression force to both sides of the at least one elastomer body. By compressing the at least one elastomer body on both sides, no shear forces are created and displacement of the elastomer body in the longitudinal direction can also be prevented. In this way, it can be ensured that a distance in the longitudinal direction between the generator-side component and the foundation-side component, which can for example be in the range of 5 to 20 mm, remains the same in the compressed and uncompressed state of the elastomer body or changes by a maximum of 10%. It may be provided that the tensioning device protrudes freely, thus without radial contact, through the elastomer body or, in the case of several elastomer bodies, protrudes between two elastomer bodies without radial contact.

In a further exemplary embodiment, the tensioning device and the counter bearing are in operative connection with one another in such a way that when the tensioning device is activated, the counter bearing is subjected to a longitudinal movement and thus compresses the at least one elastomer body in the longitudinal direction.

According to a further exemplary embodiment, the counter bearing is movably mounted with respect to the tensioning device in such a way that, in order to compress the at least one elastomer body in the longitudinal direction, in particular on both sides, the counter bearing moves towards the elastomer body in the longitudinal direction, in particular along the tensioning device.

In a further exemplary embodiment, the counter bearing has two clamping jaws, in particular tension discs, which are each arranged on a face side of the at least one elastomer body oriented in the longitudinal direction and are mounted on the tensioning device. Alternatively, or additionally, the tensioning device is formed as at least one tensioning screw. The tensioning device can also have several tensioning screws, wherein each tensioning screw can be in operative connection with a counter bearing which is formed, for example, by two clamping jaws or several tensioning screws can be in operative connection with the same two clamping jaws.

In this embodiment, the at least one elastomer body is arranged between the two clamping jaws, which move towards each other when the tensioning device is activated, in particular on the tensioning screw, and in this way compress the at least one elastomer body in the longitudinal direction, in particular on both sides. It may be provided that the clamping jaws are only in contact with the at least one elastomer body and not with the foundation-side and generator-side components and the bearing bolt. In this way, it can be ensured that the at least one elastomer body is compressed evenly from both sides. There is therefore a direct flow of force between the tensioning device, the first clamping jaw, the elastomer body, the second clamping jaw and finally the tensioning device again. The force flow is self-contained.

According to a further exemplary embodiment, at least one clamping jaw screws onto the at least one tensioning screw to compress the at least one elastomer body. To screw on the at least one clamping jaw, the clamping jaw and/or the tensioning screw can be rotated. It may also be provided that both clamping jaws are screwed onto the tensioning screw.

In a further exemplary embodiment, a strength carrier is embedded in the at least one elastomer body. The strength carrier can be made of metal, for example steel, or textile fabric, for example aramid, carbon and/or glass fibers as a braid, fabric and/or as admixed individual fibers, or comprise the aforementioned materials or components. In an exemplary further development, the strength carrier can be formed as a thin-walled perforated sheet or wire mesh hollow cylinder. The strength carrier can be used to increase the radial stiffness of the elastomer body, while the axial stiffness remains essentially unaffected. In this way, the required pretensioning force can be reduced and/or the bearing bush can be dimensioned smaller.

According to a further exemplary embodiment, the at least one elastomer body has a Shore hardness of more than 85 Shore A. The Shore hardness is a material characteristic value for elastomers and plastics, which is defined in the standards DIN EN ISO 868, DIN ISO 7619-1 and ASTM D 2240-00. The selected Shore hardness of the elastomer body ensures the necessary load capacity, wherein, for example, up to four times higher loads can be absorbed with comparable deformation compared to standard rubber-metal bearing bushes, while at the same time it is possible to dimension the bearing bush significantly smaller. In this respect, a lower component weight, lower component costs and smaller component dimensions can be achieved. Alternatively, or additionally, the elastomer body is made of polyurethane. In particular, the elastomer body can be made of polyurethane-polyester, polyester-urethane rubber or preferably of Urelast. The mentioned materials for the elastomer body have proven to be particularly advantageous, especially due to their high load-bearing capacity, high tensile strength and very good wear behavior. Due to the high load capacity in particular, it is possible to make the bearing bush smaller. This results in advantages in terms of mounting space, material requirements and costs. Urelast is generally a cast elastomer.

In an exemplary further development of the bearing bush according to the disclosure, its radial stiffness transversely to the longitudinal direction is greater than its axial stiffness in the longitudinal direction. For example, the axial stiffness is less than 10%, in particular less than 5% or in the range of 2% to 3%, of the radial stiffness. The specified ratios have proven to be particularly advantageous with regard to the specific requirements in clastic bearings in wind turbines for holding a generator-side component and a foundation-side component. When the bearing bush is used in floating bearings, a particularly low axial stiffness is desirable. Furthermore, it is possible to design the radial stiffness depending on the orientation, wherein, for example, the radial stiffness in the horizontal direction can be greater or less than the radial stiffness in the vertical direction. For example, the radial stiffnesses in the different directions can differ from each other by 5% or 8% or even more than 10%.

According to an exemplary embodiment, the at least one elastomer body has at least two support bars arranged at a distance from one another in the longitudinal direction and/or transversely, in particular perpendicularly, thereto. The support bars protrude from an outer or inner circumference of the elastomer body in such a way that a deflection space is formed between every two support bars. The deflection space can be a groove or a recess, for example. The support bars arranged on the outer circumference, hereinafter also referred to as outer support bars, are in supporting contact with the bearing parts of the elastic bearing surrounding the elastomer body on the outside in the assembled state in the bearing, in particular in the operating state. Support bars provided on the inner circumference of the elastomer body, hereinafter also referred to as inner support bars, come into load-bearing contact with the foundation-side or generator-side bearing bolt, which is accommodated in the cavity of the at least one elastomer body, in the operating state, hence in the assembled state in the bearing. Support bars that are arranged at the same axial height of the bearing bush in the longitudinal direction and are separated from each other by a deflection space, such as a groove or a recess, can be referred to as circumferential support bars. Support bars that are arranged at the same circumferential height of the bearing bush in the longitudinal direction and are separated from one another by a deflection space, such as a groove or a recess, can be referred to as axial support bars. In this way it is possible, in particular by flexibly designing the geometry of the bearing bush, to flexibly adjust the spring stiffness of the bearing bush with respect to all spatial axes, in particular in order to be able to react to any load requirements. The inventors of the present disclosure have discovered that the axial stiffness as well as the radial stiffness can be specifically adjusted in the horizontal direction on the one hand and in the vertical direction on the other hand by means of the support bar/deflection space structure of the bearing bush.

According to an exemplary further embodiment of the bearing bush according to the disclosure, the support bars are adapted to deflect on the bearing bush in the longitudinal direction and/or transversely thereto into an adjacent deflection space when a load is applied, in particular in the longitudinal direction and/or transversely thereto. In this way, it is possible to adjust the axial stiffness and/or the radial stiffness, for example depending on the expected loads, the dimensioning of the wind turbine and/or the power of the wind turbine. The axial stiffness and/or the radial stiffness can be adjusted, for example, by dimensioning the support bars and/or the grooves. In general, the higher the degree of deflection of the support bars into adjacent deflection spaces, the lower the stiffness of the elastomer body in this direction.

In a further exemplary embodiment of the bearing bush according to the disclosure, the support bars have a rectangular shape or a conical shape in cross-section. For example, it is possible for the support bars to taper in the radial direction, in particular continuously. A discontinuous taper is also conceivable. The cross-sectional shape of the support bars can also be used to specifically adjust their ability to deflect into the adjacent grooves in order to achieve a certain stiffness in this direction.

According to a further exemplary further embodiment of the bearing bush according to the disclosure, at least one support bar is segmented in the circumferential direction and/or divided into circumferential sections. The sections of the support bars that are segmented and/or divided in the circumferential direction can be referred to as circumferential support bars. The at least one support bar can be segmented or divided in the circumferential direction in such a way that at least two, three or four circumferential support bars are formed. The circumferential support bars can extend in the circumferential direction by essentially the same circumferential dimensioning. Furthermore, two adjacent circumferential support bars can be separated from each other in the circumferential direction by a recess, which is in particular rectilinear and/or oriented in the longitudinal direction and which forms the deflection space. The recesses can also be curved at least sectionally.

According to an exemplary further embodiment of the bearing bush according to the disclosure, the circumferential support bars are adapted to each deflect into an adjacent recess in the circumferential direction when a load is applied to the bearing bush, in particular transversely to the longitudinal direction. With regard to the recess and the deflection of the circumferential support bars into it, the embodiments apply analogously to the groove and the deflection of the support bars into it. The segmentation of the support bars in the circumferential direction enables additional adjustment of the stiffness of the bearing bush or the elastomer body in the circumferential direction, in particular independently of the axial stiffness or without significantly influencing the axial stiffness.

According to a further aspect of the present disclosure, which can be combined with the preceding aspects and exemplary embodiments, a bearing bush arrangement comprising several, in particular 6, 8, 12, 15, or 20 bearing bushes according to the disclosure is provided. According to the disclosure, the bearing bushes are arranged in a clock face arrangement, in particular equidistantly about an axis of a wind turbine bearing.

According to a further aspect of the present disclosure, which can be combined with the preceding aspects and exemplary embodiments, a wind turbine bearing is provided for supporting a generator-side component, such as a generator, a gearbox or an assembly unit comprising a generator and a gear, of a wind turbine on a foundation-side component, such as a support structure, of the wind turbine.

The wind turbine bearing comprises several bearing bushes according to the disclosure and/or a bearing bush arrangement according to the disclosure. It may be provided that the bearing bushes and/or the bearing bush arrangement is/are arranged at a mounting interface between the generator and the rotor. Such a wind turbine bearing offers the advantage that it requires only a small mounting space, can be manufactured at low cost and is easy and safe to mount.

In the following description of exemplary embodiments, a bearing bush according to the disclosure is generally provided with the reference number 1. A bearing bush 1 according to the disclosure can be part of a bearing bush arrangement according to the disclosure comprising at least 6, 8, 12, 15 or 20 bearing bushes. The individual bearing bushes 1 can be arranged in a clock face arrangement, in particular equidistantly around an axis of a wind turbine bearing according to the disclosure. A wind turbine bearing according to the disclosure serves to support a generator-side component 3 of a wind turbine, for example a generator, a gear or an assembly unit comprising generator and gear, on a foundation-side component 5 of the wind turbine, for example a support structure. In the wind turbine bearing, the bearing bushes 1 or the bearing bush arrangement can be arranged, for example, at a mounting interface between the generator and the rotor.

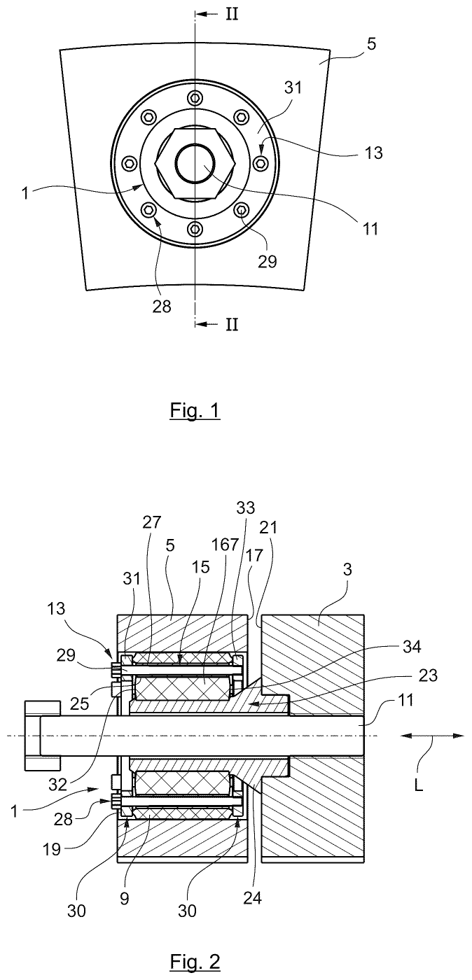

With reference to FIGS. 1 to 10, the structure and function of a bearing bush 1 according to the disclosure are explained in detail below.

FIGS. 1 to 3 show a first exemplary embodiment of a bearing bush 1 according to the disclosure. FIG. 1 shows the bearing bush 1 in a top view, wherein the foundation-side component 5 of the wind turbine is arranged in front of the generator-side component 3 and covers it. The bearing bush 1 according to the disclosure comprises the following main components (see for example FIG. 2): An inner elastomer body 7 for supporting on a generator-side bearing bolt 11 fixedly connected to the generator-side component 3; an outer elastomer body 9 for supporting on the foundation-side component 5; and a tensioning assembly 13 with a support bush 15 arranged between the inner elastomer body 7 and the outer elastomer body 9 and supported on both elastomer bodies 7, 9.

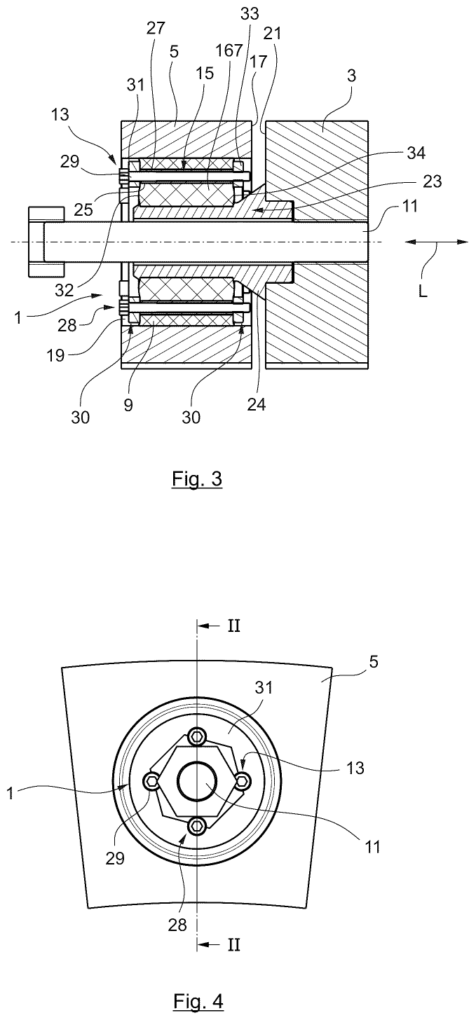

FIG. 2 and FIG. 3 show the bearing bush 1 of FIG. 1 in a sectional view along the line I-I in Figure I. It can be seen therein that the bearing bolt 11 is screwed into the generator-side component 3. The bearing bolt 11 protrudes vertically from a face 17 of the generator-side component 3 facing the foundation-side component 5 and protrudes through a through bore 19 in the foundation-side component 5. The bearing bolt 11 thus defines a longitudinal direction L of the bearing bush 1. In the embodiment shown in FIGS. 1 to 3, the bearing bolt 11 is surrounded by a hollow cylindrical bush 23, which is also screwed into the generator-side component 3. This is considered as part of the bearing bolt 11 in the following description of the function of a bearing bush 1 according to the disclosure.

In FIG. 2 and FIG. 3 it can also be seen that the entire bearing bush 1, hence the two elastomer bodies 7, 9 and the tensioning assembly 13, are arranged completely in the through bore 19 of the foundation-side component 5. In the embodiment shown in FIGS. 1 to 3, the elastomer bodies 7, 9 are hollow cylindrical and each have a cavity 8, 10 through which the bearing bolt 11 and the bushing 13 protrude. The outer elastomer body 9 is in contact with the foundation-side component 5 or with the through bore 19 of the foundation-side component 5 and the inner elastomer body 7 is in contact with the bushing 23.

In this embodiment, the support bush 15 is also formed in a rotational shape and has a hollow jacket 16 with a through-opening 26 for the tensioning device 28. The support bush 15 is arranged between the inner elastomer body 7 and the outer elastomer body 9 and separates the two elastomer bodies 7, 9 from each other. Accordingly, an inner-side jacket face 25 of the support bush 15 is supported on the inner elastomer body 7 and an outer-side jacket face 27 of the support bush 15 is supported on the outer elastomer body 9.

In the embodiment shown in FIGS. 1 to 3, the tensioning device 28 comprises eight tensioning screws 29 which are arranged rotationally and evenly around an axis of the bearing bush 1 defined by the longitudinal direction L. The support bush 15 serves to guide the tensioning screws 29 and to provide the necessary mounting space for the tensioning screws 29. The tensioning assembly 13 also comprises for each of the eight tensioning screws 29 two tension discs 31, 33 which are screwed onto the respective tensioning screw 29 and together can be referred to as counter bearings 30. The tension discs 31, 33 are located on both sides of the elastomer bodies 7, 9, in other words, the elastomer bodies 7, 9 are arranged between the tension discs 31, 33.

In FIG. 2, the bearing bush 1 or the outer elastomer body 9 is shown in an uncompressed state, which can also be referred to as the unloaded state, and in FIG. 3 in a compressed state when the tensioning assembly 13 is activated, which can also be referred to as the tensioned state. The inner elastomer body 7 is uncompressed both in the unloaded state and in the tensioned state. This allows the necessary pretensioning force of the bearing bush 1 to be reduced.

When the tensioning assembly 13 is activated, the tension discs 31, 33 on the tensioning screw 29 move in the longitudinal direction L towards the elastomer bodies 7, 9. In the embodiment shown in FIGS. 1 to 3, the tension disc 33 arranged at the end of the tensioning screw 29 screws onto the tensioning screw 29 when the tensioning screw 29 is rotated. As a result, the tension disc 33 and the tension disc 31 located on the head of the tensioning screw 29 move towards each other and compress the outer elastomer body 9 located between them in the longitudinal direction L from both sides. The outer elastomer body 9 is thereby compressed in the axial direction and expands in the radial direction, hence transversely to the axial direction or longitudinal direction L. A comparison of FIG. 2 and FIG. 3 shows that in the uncompressed state in FIG. 2, the outer elastomer body 9 protrudes beyond the support bush 15 on both sides in the longitudinal direction L and in the compressed state in FIG. 3 has the same width in the longitudinal direction L as the support bush 15. It can also be seen that in FIG. 2 there is a space between the tension discs 31, 33 and the inner elastomer body 7, which disappears when the tensioning assembly 13 is activated by the tension discs 31, 33 moving towards each other.

By compressing the outer elastomer body 9, a force-fit connection is created between the outer elastomer body 9 and the through bore 19 of the foundation-side component 5. In this way, the bearing bush 1 is tensioned or fixed in the through-opening 19 of the foundation-side component 5 and thus supports the generator-side component 3 on the foundation-side component 5. By compressing the outer elastomer body 9 on both sides, no undesirable shear forces occur and a displacement of the outer elastomer body 9 or the entire bearing bush 1 can be prevented, so that the distance between the face 21 of the foundation-side component 5 and the face 17 of the generator-side component 3 remains the same in the uncompressed and compressed state.

As can be seen in FIGS. 2 and 3, there is no radial contact between the tensioning screws 29 and the through-opening 26 of the support bush 15. There is therefore a direct flow of force between the tensioning screw 29, the first tension disc 31, the outer elastomer body 9, the second tension disc 33 and finally the tensioning screw 29 again. The flow of force is therefore self-contained.

The bearing bush 1 according to the disclosure offers the advantage that it can be mounted simply and inexpensively by being inserted from one side of the wind turbine bearing, in FIGS. 2 and 3 from the left. In the embodiment shown in FIGS. 1 to 3, the inner elastomer body 7 can be pressed onto the bushing 23 and, together with it, can be pushed into the through bore 19 of the foundation-side component 5 from the left in FIGS. 2 and 3 and screwed into the generator-side component 3. The tensioning screws 29 can be tightened to activate the tensioning device 13. This allows the bearing bush 1 to be mounted without the need for difficult-to-handle hydraulic tensioning tools. A face 21 of the foundation-side components 5 facing the generator-side components 3 is aligned parallel to the face 17 of the generator-side component 3. The distance between the face 17 of the generator-side component 3 and the face 21 of the foundation-side component 5 is approximately 5 mm to 20 mm.

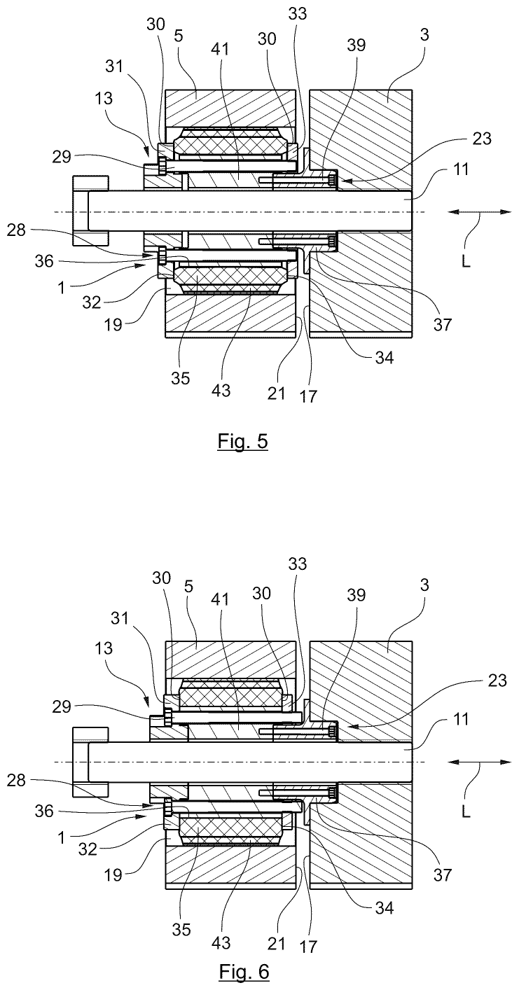

FIGS. 4 to 6 show a further embodiment of a bearing bush 1 according to the disclosure. FIG. 4 shows the bearing bush 1 in a top view from the side of the foundation-side component 5 of the wind turbine, which covers the generator-side component 3. FIGS. 5 and 6 each show the bearing bush 1 of FIG. 4 in a sectional view along line II-II in FIG. 4, wherein the bearing bush is shown in an uncompressed state in FIG. 5 and in a compressed state in FIG. 6. The embodiment in FIGS. 4 to 6 basically has the same components and the same advantages as the bearing bush 1 in FIGS. 1 to 3, so that only the differences to the first exemplary embodiment in FIGS. 1 to 3 are explained below.

Instead of the inner elastomer body 7 and the outer elastomer body 9, the bearing bush 1 in FIGS. 4 to 6 has only one elastomer body 35 with a cavity 36. When the tensioning assembly 13 is activated, the elastomer body 35 is compressed in the longitudinal direction L, like the outer elastomer body 9 in FIGS. 1 to 3, and expands radially in order to fix the bearing bush 1 in the through bore 19 of the foundation-side component 5. Instead of the bushing 23, a mounting flange 37 is provided, which is screwed into the generator-side component 3 and a bushing 41 connected to it via screws 39. The bushing 23 has a wedge 24 facing the generator-side component 3, which is oriented in the direction of the foundation-side component 5, so it tapers in the direction of the foundation-side component 5. The wedge 24 favors the axial fixing of the bearing bush 1. In this embodiment, the elastomer body 35 rests with the inner side 51 against the bush 41, which serves as a support bush 15, guiding the tensioning device 28 and providing the necessary mounting space for the tensioning device 28. In the embodiment shown in FIGS. 4 to 6, the tensioning device 28 has four tensioning screws 29, which are evenly distributed around the circumference of the support bush 15.

A strength carrier 43 is embedded in the elastomer body 35, which is made of metal, for example steel, or textile fabric, for example aramid, carbon and/or glass fibers as a braid, fabric and/or as admixed individual fibers. In the embodiment shown in FIGS. 4 to 6, the strength carrier 43 is formed as a thin-walled hollow cylinder. Due to the strength carrier 43, the radial stiffness of the elastomer body 35 can be increased, while the axial stiffness of the elastomer body 35 remains unchanged. In this way, the required pretensioning force can be reduced and the bearing bush 1 can be dimensioned smaller overall. The radial stiffness is significantly greater than the axial stiffness. For example, the axial stiffness of the elastomer body 35 can be in the range of 2% to 3% of the radial stiffness of the elastomer body 35.

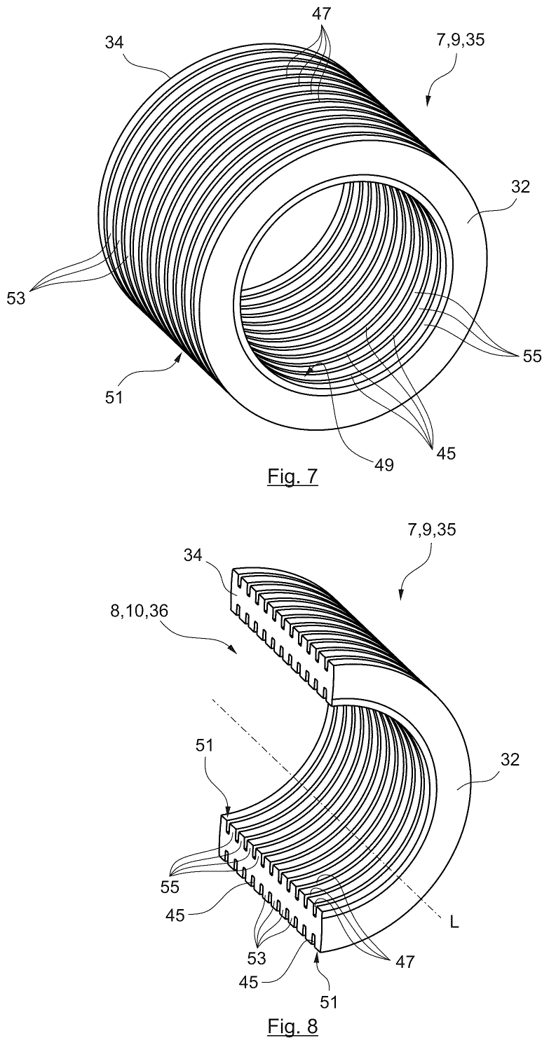

Both the inner elastomer body 7 and the outer elastomer body 9 in the embodiment shown in FIGS. 1 to 3 and the elastomer body 35 in FIGS. 4 to 6 have a Shore hardness of more than 85 Shore A. The elastomer bodies 7, 9, 35 are made of polyurethane or preferably of Urelast and can have a varying axial stiffness in the longitudinal direction L, which is explained below with reference to FIGS. 7 to 10.

FIGS. 7 and 8 show a first exemplary embodiment of an elastomer body 7, 9, 35. The elastomer body 7, 9, 35 is embodiment segmented in the longitudinal direction L and has a plurality of circumferential grooves 45, 47 on the inner side 49 of the elastomer body 35 and on the outer side 51 of the elastomer body 35. The grooves 45, 47 form a deflection space into which the elastomer material of the support bars 53, 55 arranged between the grooves 45, 47 can deflect when compressing the elastomer body 7, 9, 35. The support bars 53, 55 can be referred to as axial support bars.

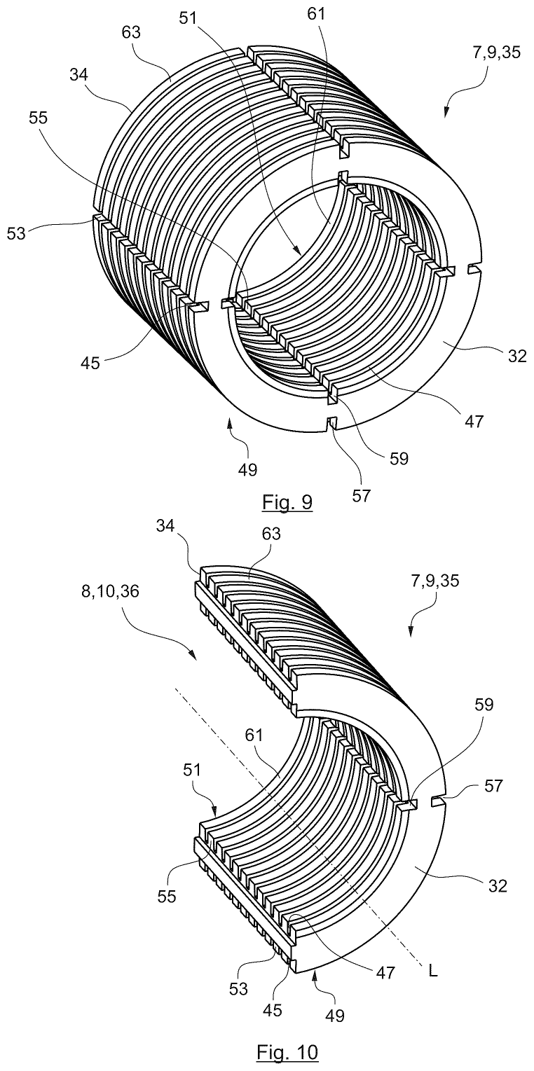

FIGS. 9 and 10 show a further embodiment of an elastomer body 7, 9, 35, which is also segmented in the longitudinal direction L by circumferential grooves 45, 47 and axial support bars 53, 55 arranged therebetween and is additionally also segmented in the radial direction. For this purpose, the elastomer body 7, 9, 35 has four grooves 57, 59 distributed evenly in the circumferential direction on the inner side 49 and on the outer side 51 of the elastomer body 7, 9, 35. The space between the grooves 57, 59 can be referred to as circumferential support bars 61, 63. When compressing the elastomer body 7, 9, 35, the elastomer material of the circumferential support bars 61, 63 deflects accordingly into the grooves 57, 59. The grooves 57, 59 thus divide the axial support bars 53, 55 on the inner side 49 and the outer side 51 of the elastomer body 7, 9, 35 into four circumferential support bars 61, 63 respectively.

The axial support bars 53, 55 and the circumferential support bars 61, 63 allow the spring stiffness of the bearing bush 1 to be flexibly adjusted in the radial and axial directions in order to be able to respond to any load requirements. The higher the degree of deflection of the support bars 53, 55 into adjacent deflection spaces 47, 49, the lower the stiffness of the elastomer body 7, 9, 35. Both the axial support bars 53, 55 and the circumferential support bars 61, 63 have a rectangular shape in cross-section in FIGS. 7 to 10. The grooves 45, 47 and the grooves 57, 59 also have a rectangular shape in cross-section.

The features disclosed in the above description, the figures and the claims can be of importance both individually and in any combination for the realization of the disclosure in the various embodiments.

### REFERENCE LIST

1 bearing bush
3 generator-side component
5 foundation-side component
7 inner elastomer body
8 cavity
9 outer elastomer body
10 cavity
11 bearing bolt
13 tensioning assembly
15 support bush
16 jacket
17 face of generator-side component
19
21 through-opening
23 face of foundation-side component
21
23 bush
24 wedge
25 inner-side jacket face
26 through-opening
26
27 outer-side jacket face
28 tensioning device
29 tensioning screw
30 counter bearing
31 tension disc
33 tension disc
35 elastomer element
36 cavity
37 mounting flange
39 screw
41 support bush
43 strength carrier
45, 47 circumferential groove
49 elastomer body inner side
51 elastomer body outer side
53, 55 axial support bars
57, 59 grooves
61, 63 circumferential support bars
L longitudinal direction

1. A bearing bush adapted to movably hold a generator-side component and a foundation-side component of a wind turbine, the bearing bush comprising:
an elastomer body having a cavity adapted to receive a foundation-side or generator-side bearing bolt defining a longitudinal direction; and
a tensioning assembly adapted to compress the elastomer body on both sides in the longitudinal direction such that, in response to a compressing of the elastomer body, the tensioning assembly is adapted to exert a pretensioning force directed in the longitudinal direction on both sides of the elastomer body.

2. The bearing bush according to claim 1, further comprising a support bush supporting the elastomer body transversely to the longitudinal direction and adapted to accept a mounting of the tensioning assembly thereon.

3. A bearing bush adapted to movably hold a generator-side component and a foundation-side component of a wind turbine, the bearing bush comprising:
an inner elastomer body adapted to be support on a foundation-side or generator-side bearing bolt defining a longitudinal direction;
an outer elastomer body adapted to be supported on the foundation-side or generator-side component; and
a tensioning assembly with a support bush arranged between the inner elastomer body and the outer elastomer body and supported on both the inner elastomer body and the outer elastomer body, wherein the tensioning assembly is adapted to compress at least one of the inner elastomer body and the outer elastomer body in the longitudinal direction.

4. The bearing bush according to claim 3, wherein:
in an unloaded state of the tensioning assembly, both of the inner and the outer elastomer bodies are in an uncompressed state; and
in a tensioned state of the tensioning assembly, exactly one of the inner and the outer elastomer bodies is compressed in the longitudinal direction and the other elastomer body is in the uncompressed state.

5. The bearing bush according to claim 3, wherein the support bush has a rotationally shaped, hollow jacket which has a through-opening adapted for the tensioning assembly and whose inner-side jacket face is supported on the inner elastomer body or on the bearing bolt, and whose outer side-jacket face is supported on the outer elastomer body.

6. A bearing bush adapted to movably hold a generator-side component and a foundation-side component of a wind turbine, the bearing bush comprising:
an elastomer body with a cavity adapted to receive a foundation-side bearing bolt or a generator-side bearing bolt, defining a longitudinal direction; and
a tensioning assembly adapted to compress the elastomer body in the longitudinal direction, wherein the elastomer body has a stiffness which varies in the longitudinal direction.

7. The bearing bush according to claim 6, wherein the tensioning assembly comprises: a tensioning device and a counter bearing movably mounted with respect to the tensioning device, the counter bearing being adapted to apply a compression force in the longitudinal direction to the elastomer body.

8. The bearing bush according to claim 7, wherein the tensioning device and the counter bearing are operatively connected to one another such that, upon activation of the tensioning device, the counter bearing is adapted to be set into a movement in the longitudinal direction.

9. The bearing bush according to claim 7, wherein the counter bearing is mounted movably with respect to the tensioning device such that, to compress the elastomer body in the longitudinal direction, the counter bearing is adapted to move in the longitudinal direction towards the elastomer body.

10. The bearing bush according to claim 7, wherein;
the counter bearing comprises two clamping jaws each arranged on a face side of the at least one elastomer body oriented in the longitudinal direction and are mounted on the tensioning device, and/or
the tensioning device is formed as a tensioning screw.

11. The bearing bush according to claim 10, wherein at least one of the two clamping jaws is adapted to be screwed onto the tensioning screw to compress the elastomer body.

12. The bearing bush according to claim 6, further comprising a strength carrier embedded in the elastomer body.

13. The bearing bush according to claim 6, wherein the elastomer body has a Shore hardness of more than 85 Shore A and/or is made of polyurethane.

14. The bearing bush according to claim 6, wherein the bearing bush has a radial stiffness transversely to the longitudinal direction that is greater than its axial stiffness in the longitudinal direction.

15. The bearing bush according to claim 6, wherein the elastomer body comprises at least two support bars arranged at a distance from one another in the longitudinal direction and/or transversely thereto, the at least two support bars project from an outer or inner circumference of the elastomer body to form a deflection space between each of the at least two support bars.

16. The bearing bush according to claim 15, wherein the at least two support bars are adapted to deflect onto the bearing bush, in the longitudinal direction and/or transversely thereto, into an adjacent deflection space in response to a load being applied.

17. The bearing bush according to claim 15, wherein the at least two support bars are rectangular in cross-section, or have a conical shape and/or taper in a radial direction.

18. The bearing bush according to claim 15, wherein at least one of the at least two support bars is segmented in a circumferential direction to form circumferential support bars.

19. The bearing bush according to claim 18, wherein the circumferential support bars are adapted to deflect in the circumferential direction into an adjacent recess in response to a load being applied to the bearing bush.

20. A bearing bush arrangement comprising bearing bushes according to claim 6, wherein the bearing bushes are arranged in a clock face arrangement about an axis of a wind turbine bearing.

21. A wind turbine bearing adapted to support a generator-side component of a wind turbine on a foundation-side component of the wind turbine, the wind turbine bearing comprising:
a plurality of bearing bushes according to claim 6, wherein the bearing bushes are arranged at an assembly interface between the generator-side component and a rotor.
